(19) United States
(12) Patent Application Publication
(10) Pub. No.: US 2025/0230886 A1
(43) Pub. Date: Jul. 17, 2025

(54) SUBSEA PIPE ENDS CONNECTIONS

(71) Applicant: DeepOcean AS, Haugesund (NO)

(72) Inventors: Anders Sandvik, HAUGESUND (NO); David Lampe, HAUGESUND (NO); Christian Hovden Gade, HAUGESUND (NO); Bjarne Magnussen, ÅKREHAMN (NO); Ørjan Merkesvik, HAUGESUND (NO); Bård Austarå, KOLNES (NO)

(73) Assignee: DeepOcean AS, Haugesund (NO)

(21) Appl. No.: 19/015,844

(22) Filed: Jan. 10, 2025

(30) Foreign Application Priority Data
Jan. 12, 2024 (NO) 20240037

(51) Int. Cl. F16L 37/00; F16L 37/12

(52) U.S. Cl. CPC F16L 37/002; F16L 37/12

(57) ABSTRACT

A clamp device in various examples facilitates fluid tightness of a subsea pipe ends connection between first and second pipes arranged end to end. Systems, apparatuses, and methods in various examples include pipe adapter devices which couple the clamp device to the arrangement of first and second pipes, the clamp device having first and second clamp members for urging the pipe ends together by varying or setting a spacing between the first and second clamp members along the pipes and actuation means for operating the first and second clamp members to vary or set the spacing.

### CROSS REFERENCE TO RELATED APPLICATION

The present application claims priority to Norwegian Patent Application No. 20240037, filed Jan. 12, 2024 which is hereby incorporated herein by reference in entirety.

### FIELD

The present invention relates to subsea pipe ends connections, and in particular, to clamp devices, pipe adapter devices, related apparatus and systems, methods of installation and use, in connection with facilitating fluid tightness of subsea pipe ends connections.

BACKGROUND

In various infrastructures subsea, pipe connections are formed using pipe clamps to provide the necessary force for sealed connection between juxtaposed pipe ends. After prolonged use, clamp parts may deteriorate, and experience failures leading to loss of sealing integrity at the connection. Such failure can be exacerbated in the case of pipes carrying corrosive substances where the substance itself may accelerate the deterioration. Undesired leakages of harmful substance such as oil and gas into the environment may ensue. Failures of this kind can be a significant concern in relation to prior art clamps susceptible to Hydrogen Induced Stress Cracking (HISC). For example, failures can occur in clamp leadscrews and hinges.

There is a need to mitigate such risks. Current practice is to replace the clamps, which typically requires shutting down production and transmission of fluids for significant periods of time, in particular where subsea pipelines are concerned and where such pipelines carry hydrocarbons from wells through subsea well production infrastructures. Such a solution can be time consuming, challenging, and costly.

### SUMMARY

According to a first aspect of the invention, there is provided a clamp device for facilitating fluid tightness of a subsea pipe ends connection between first and second pipes arranged end to end, the clamp device comprising: first and second clamp members for urging the pipe ends together in use by varying or setting a spacing between the first and second clamp members along the pipes; and actuation means for operating the first and second clamp members to vary or set the spacing.

Thus, the clamp device in use may be applied to the first and second pipes and urge the pipe ends together to facilitate fluid tightness of the subsea pipe ends connection. The first and second clamp members may be movable toward or away from one another along the arranged first and second pipes to set or vary the spacing. Clamping force may be exerted from the first and clamp members to urge the pipe ends toward one another, determined by the setting and/or spacing of the first and second clamp members along the pipes. The first clamp member may be for engaging the first pipe, and the second clamp member may be for engaging the second pipe. The first clamp member may engage the first pipe, e.g. through a coupling of the first clamp member and a pipe adapter means, at a location along the first pipe on one side of the pipe ends connection. The second clamp member may engage the second pipe, e.g. through a coupling of the first clamp member and a pipe adapter means, at a location along the second pipe on the other side of the pipe ends connection.

Preferably, the clamp device is configured to extend over the pipe ends connection. More preferably the clamp device is configured to extend over the pipe ends connection so that the pre-existing clamp is not required to be removed and/or can remain in place. Thus, the clamp device can be used in examples where the pipe ends connection has a pre-existing clamp applied.

The clamp device may have a bridge structure configured to extend over the pipe ends connection. The bridge structure may comprise any of: a section of the first clamp member; a section of the second clamp member; a bridge section extending between the first and second clamp members; at least one connecting body coupling between the first and second members. The bridge section may comprise or include the at least one connecting body. The bridge section may connect between the first and second clamp members. The bridge section or bridge structure may be configured to define an open space between an outside of the pipes or pipe ends connection and the bridge section or bridge structure, upon application to the first and second pipes. The open space may be defined between an outside of a pre-existing clamp of the pipe ends connection and the bridge section or bridge structure.

Typically, the first and second clamp members are coupled. The clamp device may comprise a connecting structure, e.g. at least one connecting body, for coupling the first and second clamp members.

Typically, the first and second clamp members are arranged for rotational movement therebetween, e.g. hinged or pivotable, by rotating either or both of the clamp members. The first and second clamp members may be moved toward or away from one another through rotational movement therebetween. The actuation means may accordingly be operable for driving the first and second clamp members to rotate relative to one another.

The rotational movement may be produced through rotation of either or both the first and second clamp members relative to one another. By way of the rotational movement, the spacing between the first and second clamp members along the pipe may be set or varied. The first and second clamp members may be coupled to one another, optionally via one or more connecting bodies, through at least one pivot or rotational coupling, for permitting rotation between the first and second clamp members.

In this way, upon rotation therebetween, the clamp device can be moved between a configuration in which either or both the first and second clamp members are disengaged from either or both the first and second pipes and a configuration in which the first and second clamp members are engaged with first and second pipes.

Typically, the clamp members are arranged for coupling the clamp device to the arrangement of first and second pipes by varying and reducing the spacing between the first and second clamp members along the pipes.

Typically, the first clamp member has at least one clamping portion for interlocking, engaging, or linking with corresponding first pipe means.

Typically, the second clamp member has at least one clamping portion for interlocking, engaging, or linking with corresponding second pipe or pipe means.

Typically, the first or second clamp member has one or more clamping portions for locking a pipe adapter means to the pipe.

Typically, the spacing between the first and second pipe members may comprise a clamp space for receiving one or more clampable parts associated with the first or second pipe. For example, the first and second clamp members may be configured to define a clamp space in which first and second end portions of the first and second pipes respectively may in use be received for clamping, or in which first and second end wall portions associated with the first and second pipes respectively, for example wall portions of first and second pipe adapter means or wall portions of first and second pipe hubs of the first and second pipes, may be received for clamping. Through clamping the clampable parts, the pipe ends of first and second pipes may thus be urged together to facilitate fluid tightness.

Typically, the clamp device may further comprise a first drive part associated with the first clamp member and a second drive part associated with the second clamp member. The actuation means may be coupled to the first and second drive parts. The actuation means may be arranged to drive movement of the first and second clamp members toward or away from one another, e.g. rotatably, for varying or setting the spacing between the clamp members along the pipes.

The actuation means may be operable in one mode for urging the first and second the drive parts away from one another, for thereby reducing or tightening the spacing between the first and second clamp members along the pipes. The actuation means may be operable in another mode for driving or urging the first and second drive parts toward one another, for thereby increasing or relaxing the spacing between the first and second clamp members along the pipes.

Typically, the actuation means comprises an actuation mechanism. The actuation mechanism may be variable in extent, e.g. may be extendable and/or retractable, between the first and second drive parts for operating the first and second clamp members for varying or setting the spacing therebetween. The actuation mechanism may comprise an arrangement of coupled parts, which arrangement may be extendable and retractable between the drive parts of the first and second clamp members. The actuation mechanism and/or arrangement of coupled parts may be connected to the first and second drive parts.

The actuation mechanism may thus be arranged to transmit force to the drive parts and to the clamp members for urging the first and second clamp members toward one another for engaging the first and second pipes and/or urging the pipe ends together.

Typically, the actuation mechanism comprises a tension rod operable for varying the extent of the actuation mechanism and/or for varying or setting the spacing between the first and second clamp members.

For example, the actuation mechanism may comprise a tension rod, a first element coupled to the tension rod, a second element coupled to the tension rod, the tension rod extending between the first and second elements, wherein the first and second elements may be movable one relative to the other along the tension rod, so that when moved apart along the tension rod, the extent of the actuation mechanism between the first and second drive parts of the clamp device may be reduced and when moved toward one another along the tension rod, the extent of the actuation mechanism between the first and second drive parts of the clamp device may be increased. When the extent of the actuation mechanism between the first and second drive parts of the clamp device is increased, the first and second clamp members may be driven to reduce and/or tighten the spacing between the first and second clamp members along the pipes. This may facilitate increasing or maintaining clamping force upon one or more parts associated with the first or second pipes between the first and second clamp members, for example parts received in the clamp spacing, such as a part of a first pipe adapter means and a part of a second pipe adapter means, for clamping. This may further facilitate urging the pipe ends together with increased or sufficient force for obtaining or maintaining fluid tightness of the pipe ends connection.

The tension rod may be operable, e.g. pulled or manipulated using an actuation tool, to move or position either or both the first and second elements of the actuation mechanism along the rod. Either or both the first and second elements may be operable, e.g. manipulated using a tool, to move and/or position either or both the first and second elements along the rod. The tension rod may be arranged to extend longitudinally in tension between the first and second elements. For example, in operational use, for example when the first and second clamp members are operated to urge the pipe ends of the first and second pipes together, for example with clamping force being applied to parts associated with the first and second pipes and received in the variable spacing therebetween, the tension rod may extend in tension between the first and second elements.

The actuation mechanism may be variable in extent between drive parts along a first, drive axis, e.g. linearly. The first axis may be a direction parallel to the longitudinal axis of the pipes. The tension rod may extend between the first and second elements along a second, axis, which may be perpendicular to the first, drive axis.

In various examples, the actuation mechanism may have a first linkage coupling between the drive parts of the first and second clamp members and a second linkage coupling between the drive parts of the first and second clamp members. The linkages can together extend or retract in extent along the drive axis. The first element may be an element of the first linkage and the second element may be an element of the second linkage. The first and second linkages may cooperate to vary an extent of the actuation mechanism along the first drive axis. The first linkage couples to the rod through a first element, e.g. the first intermediate element, at a first position along the rod, and the second linkage couples to the rod through a second element, e.g. the second intermediate element at a second position along the rod.

The tension rod extending between the first and second elements may have a rod tension that is variable. The tension rod may be operable to vary the rod tension. Varying the rod tension may vary the force applied by the first and second clamp members to the first and second pipes in use and with which the pipe ends may be urged together. Thus, the rod tension may be varied for obtaining desired clamping force and facilitating fluid tightness.

Typically, the tension rod may be configured to be pulled longitudinally for varying the extent of the actuation mechanism between the first and second drive parts. For example, the tension rod may be pulled so as to move the actuation mechanism, and/or the arrangement of coupled parts, between one configuration in which the actuation mechanism and/or the arrangement of coupled parts has a first extent between the first and second drive parts, and another configuration in which the actuation mechanism and/or the arrangement of coupled parts has a second extent between the drive parts.

Thus, the actuation mechanism may be a tension rod actuation mechanism that includes a tension rod for varying the extent of the actuation mechanism, e.g. varying the extent of the arrangement of coupled parts.

Optionally, the clamp device further comprises at least one sensor or detection means configured for any of: detecting an amount of extension of the actuation mechanism, detecting an amount of tension of a tension rod of the actuation mechanism, detecting an amount of clamping force produced by the clamp device when in use. In such examples, the actuation mechanism may be operable to vary or adjust or set the spacing between the first and second clamp members, in response to or in dependency upon the detected amount.

According to a second aspect of the invention, there is provided a system comprising: a subsea pipe ends connection comprising first and second pipes arranged longitudinally end-to-end; and a subsea clamp device in accordance with the first aspect of the invention.

The clamp device may be installed upon and may be coupled to the first and second pipes, typically through pipe adapter means on either or both the first and second pipes. The clamp device may be arranged on the pipes with the first and second clamp members and the spacing between the first and second clamp members along the pipes being determined or set or varied by use of the actuation means. The first and second clamp members may be coupled to the first and second pipes, e.g. through the pipe adapter means, and operated by the actuation means to urge the pipe ends together to facilitate fluid tightness of the subsea pipe ends connection. Either or both of the first and second pipes may have or be provided with a pipe means or a pipe adapter means, e.g. the first pipe may be provided with first pipe means or first pipe adapter means, e.g. the second pipe may be provided with second pipe means or second pipe adapter means. Either or both of the first and second pipes may have or be provided with end hubs. The pipe adapter means may be located on the pipe adjacent to, e.g. in abutment with, the end hub. The first clamp member may be coupled to the first pipe via first pipe means or first pipe adapter means. The second clamp member may be coupled to the second pipe via second pipe means or first pipe adapter means.

Preferably, the clamp device is arranged to extend over the pipe ends connection. Typically, the pipe ends connection has a pre-existing clamp applied, and the clamp device is arranged to extend over or across the pipe ends connection and over or across the pre-existing clamp. Typically, the clamp device has a structure extending from the first clamp member on one side of the pipe ends connection to the second clamp member on the other side of the pipe ends connection, e.g. comprising or forming bridge section therebetween, above or across the pipe ends. An open space may be defined between an outer surface of the pre-existing clamp and a section of the structure, e.g., a bridge section, of the clamp device.

Typically, the first and second clamp members may be operated to move toward one another, thus reducing the spacing between the first and second clamp members along the pipes, to couple the clamp device to the pipes and/or the pipe adapter means.

In the coupled configuration, the first clamp member may interlock, engage, and/or couple with any of: the first pipe, first pipe means, and first pipe adapter means, and the second clamp member may interlock, engage, and/or couple with any of: the second pipe, second pipe means, or second pipe adapter means.

Typically, the first and second clamp members may at least one be movable toward the other to move from a decoupled configuration to the coupled configuration. In the decoupled configuration, the first clamp member may have a first position along the first pipe, and the second clamp member may have a first position along the second pipe. In the coupled configuration the first clamp member may have a second position along the first pipe, and the second clamp member may have a second position along the second pipe. In the coupled configuration alternatively, the first clamp member may have a first position along the first pipe and the second clamp member may have a second position along the second pipe, or the first clamp member may have a second position along the first pipe and the second clamp member may have a first position along the second pipe.

Typically, the first and second clamp members are urged toward one another by the actuation means operating the first and second clamp members for exerting a clamping force upon one or more parts received in the spacing between the first and second clamp members of the clamp device, which one or more parts received in the spacing may comprise one or more parts of or associated with the first pipe, first pipe means, or first pipe adapter means, and one or more parts of or associated with the second pipe, second pipe means, or second pipe adapter means. The parts received in the spacing may thus be clamped upon operation of the actuation means to urge the clamp members toward one another to tighten the space.

To this end, the first clamp member may abut a surface of part of the first pipe, first pipe means, or first pipe adapter means within the space between the first and second clamp members, and the second clamp member may abut a surface of part of the second pipe, second pipe means, or second pipe adapter means within the space between the first and second clamp members. Clamping force may be exerted from the first and clamp members to urge the pipe ends toward one another, determined by the setting and/or spacing of the first and second clamp members along the pipes.

The first/second pipe adapter means may comprise first and second limbs extending around the first/second pipe which limbs may be rotated from open position to closed position around the pipe for facilitating installation of the first/second pipe adapter means. In coupled configuration, the first/second clamp member may be coupled to the first pipe adapter means i) such that the first and second limbs of the first/second pipe adapter means may be locked in location along the first/second pipe and/or prevented or blocked from inadvertent rotation away from the pipe toward open position, or ii) such that the clamp device may be locked to the first/second pipe adapter means and/or the first/second clamp member may be blocked by part of the first/second pipe adapter means from decoupling from the pipe adapter means.

The first clamp member may comprise at least one part configured to interlock and/or engage with a formation or structure of any of the first pipe, first pipe means, or first pipe adapter means. The part may comprise at least one clamping portion. The second clamp member may comprise at least one part configured to interlock and/or engage with a formation or structure of any of the second pipe, second pipe means or second pipe adapter means. The part may comprise at least one clamping portion. Thus, through the interlock and/or engagement, the first and second clamp members and/or the clamp device may be coupled to the first and second pipes. The formation or structure may comprise at least one abutment surface, at least one longitudinally extending groove or slot or recess, or at least one radial protrusion or wall. The part configured to be interlock or engage with the formation or structure may comprise at least one abutment surface, at least one groove or slot or recess, or at least one radial protrusion.

The part configured to interlock or engage with the formation or structure may be configured to be located in the groove or slot or recess. The part may move along the groove or slot or recess from decoupled to coupled configuration. The groove or slot or recess may extend longitudinally along the pipes. Alternatively, the part configured to interlock or engage with the formation or structure may comprise a groove or slot or recess in which an element of the formation or structure is received.

Advantageously, the pipe adapter means may be provided on the pipe by locating the pipe adapter means on the pipe in a locating process. The pipe adapter means can thus advantageously adapt the pipe to make possible coupling and/or interlocking engagement of clamp member(s) of the clamp device to the pipe(s).

Typically, the first clamp member comprises at least one clamping portion, e.g. first and second clamping portions, and the second clamp member comprises at least one clamping portion, e.g. the third and fourth clamping portions. More specifically, the at least one clamping portion of the first clamp member may be configured to couple, engage, or interlock with the first pipe, first pipe means, or first pipe adapter means. The at least one clamping portion of the second clamp member may be configured to couple, engage, or interlock with the second pipe, second pipe means or second pipe adapter means.

The first and second clamping portions may be configured to straddle the first pipe such that the first and second clamping portions are disposed on opposite sides of the first pipe. The third and fourth clamping portions may be configured to straddle the second pipe such that the third and fourth clamping portions are disposed on opposite sides of the second pipe.

The first clamp member or the at least one clamping portion thereof may comprise a convex surface configured to engage or abut complementary concave surface of the first pipe, first pipe means or first pipe adapter means. The first clamp member or the at least one clamping portion thereof may be received in a formation or structure such as a slot, recess or groove of the first pipe, first pipe means, or first pipe adapter means. The second clamp member or the at least one clamping portion thereof may comprise a convex surface configured to engage or abut complementary concave surface of the second pipe, second pipe means, or second pipe adapter means. The second clamp member or the at least one clamping portion thereof may be received in a formation or structure such as a slot, recess or groove of the second pipe, second pipe means, or second pipe adapter means.

Typically, the first and second clamp members may be further configured to receive in the spacing between the first and second clamp members any one or more of: the pipe ends; the pipe means; the pipe adapter means; or one or more parts thereof. The clamp members may be arranged to abut an abutment surface of any of the pipe ends; the pipe means; the pipe adapter means, or part thereof.

The pipe means may comprise or be a pipe end hub. The pipe means may comprise or be pipe adapter means.

According to a third aspect of the invention, there is provided apparatus for facilitating fluid tightness of a subsea pipe ends connection of first and second pipes arranged longitudinally end-to-end, the apparatus comprising: a clamp device according to the first aspect of the invention; and at least one pipe adapter means for coupling the clamp device to the arrangement of first and second pipes.

Typically, the pipe adapter means may comprise any of: a collar; a clamp; a ring structure configured to extend around the first or second pipe. The pipe adapter means may comprise first and second rotatably coupled limbs configured to extend at least partially around the pipe.

Typically, the pipe adapter means may comprise a structure, formation or part configured to interlock, engage and/or couple to a structure, formation or part of a clamp member. The interlocked, engaged or coupled structures, formations or parts, may be complementary parts. The structure of the pipe adapter means may comprise any of: a recess, a slot, a formation, a groove, configured to complement and/or receive a complementing part of the clamp member therein. The clamp member may be coupled to the pipe adapter means through the engagement, interlocking and/or coupling of the structures, formations or parts of the clamp member and the pipe adapter means. The pipe adapter means may typically comprise at least one abutment surface arranged to be engaged by at least one part, e.g. clamping portion, of the clamp member. The pipe adapter means may be a first pipe adapter means or a second pipe adapter means.

Typically, the apparatus comprises first and second pipe adapter means. The first pipe adapter means may comprise a first limb having a slot or recess for receiving part of the first clamp member and a second limb having a slot or recess for receiving further part of the first clamp member, which part may comprise a first clamping portion, and which further part may comprise a second clamping portion. The second pipe adapter means may comprise a first limb having a slot or recess for receiving part of the second clamp member and a second limb having a slot or recess for receiving further part of the second clamp member, which part may comprise a third clamping portion, and which further part may comprise a fourth clamping portion.

Typically, the apparatus has first pipe adapter means and second pipe adapter means. The first and second clamp members may be arranged to receive a part of the first pipe adapter means and a part of the second pipe adapter means in the spacing therebetween, and the first and second clamp members may be operable to exert a clamping force to the parts of the first and second pipe adapter means received in the spacing therebetween along the pipes in use. At least one part, e.g. at least one clamping portion, of the first clamp member may be urged along the first pipe against at least one abutment surface of the first pipe adapter means received in the clamp spacing in one direction and at least one part, e.g. at least one clamping portion, of the second clamp member may be urged along the second pipe against at least one abutment of the first of the second pipe adapter means in the clamp spacing in opposite direction along the pipes for urging the pipe ends together in use. The abutment surfaces may be a surface of a recess, slot, structure or formation engageable through movement of the clamp members toward one another reducing or tightening the spacing along the pipes. The surface of the recess may be, e.g. an end surface of the slot of the pipe adapter means along the pipe.

Typically, the first and second clamp members are configured for coupling the clamp device to the first and second pipe adapter means. The first clamp member may be configured to couple, interlock, and/or engage with first pipe adapter means or a formation, structure or part thereof. The second clamp member may be configured to couple, interlock and/or engage with the second pipe adapter means or a formation, structure or part thereof.

The actuation means of the clamp device may comprise an actuation mechanism which is variable in extent. The apparatus may further comprise at least one sensor or detection means configured for any of: detecting an amount of extension of the actuation mechanism, detecting an amount of tension of a tension rod of the actuation mechanism, detecting an amount of clamping force produced by the clamp device. In such examples, the actuation mechanism may be operable to vary, set or adjust the spacing along the pipes of the first and second clamp members, in response to or in dependency upon the detected amount.

Typically, the apparatus further comprises an operating tool for operating the actuation means. In certain examples, the operating tool may be a subsea tool for pulling a tension rod of the actuation mechanism and locking the tension rod with a rotating nut.

According to a fourth aspect of the invention, there is provided a pipe adapter device for coupling between a subsea pipe and a clamp device in accordance with the first aspect of the invention, the pipe adapter device comprising first and second limbs and at least one recess or slot configured to be engageable by at least one coupling part of a clamp member.

The first limb may be arranged to locate around the pipe on one side of the pipe, and the second limb may be arranged to locate around the pipe on an opposite side of the pipe, the recesses or slots arranged for receiving therein first and second legs of the clamp member on either side of the pipe.

According to a fifth aspect of the invention, there is provided a method which comprises installing the clamp device in accordance with the first aspect of the invention, the clamp device to be installed on first and second pipes which are located subsea and arranged longitudinally end to end and have a subsea pipe ends connection therebetween.

The method may further include installing first pipe adapter means on the first pipe and second pipe adapter means on the second pipe. The method may further include providing the clamp device and coupling the clamp device to the first and second pipes, e.g. via at least one pipe adapter device. The method may include coupling the first and second clamp members to the first and second clamp devices, thereby coupling the clamp device to the first and second pipes. The method may include operating the first and second clamp members using the actuation means to couple the clamp device to the first and second pipes or first and second pipe adapter means, the spacing between the first and second clamp members along the pipes being reduced or tightened longitudinally along the pipes by the first and/or second clamp members being moved with relative motion therebetween toward one another.

The first pipe adapter means once installed may be located in fixed position relative to the first pipe and the second pipe adapter means once installed may be located in fixed position relative to the second pipe.

Typically, the at least one adapter means comprises rotatably coupled first and second limbs which may be configured to extend along a circumference around the pipe and are rotatable between a first configuration in which the limbs allow the pipe to be received in a region between the first and second limbs and a second configuration in which the limbs may be closed against the pipe on opposite sides thereof, and wherein the installing of the at least one adapter means may comprise: landing the adapter means on the pipe in the first configuration; and letting the first and second limbs rotate under gravity from the first configuration to the second configuration.

The method may further comprise lowering the at least one pipe adapter means through sea, supported on one or more lifting lines, and relaxing at least one lifting line to let the limbs rotate from the first to the second configuration.

Optionally, the method may further comprise arranging the first pipe adapter means rearward of and in abutment against a pipe end hub of the first pipe, and arranging the second pipe adapter means rearward of and in abutment against the pipe end hub of the second pipe, the pipe end hubs thus hindering longitudinal movement or further longitudinal movement of the first pipe adapter means relative to the first pipe toward the first pipe end and the second pipe adapter means relative to the second pipe to the second pipe end.

In some examples, the pipe ends may be arranged end to end with a previously installed clamp connecting the ends. In such examples, the method may further include determining whether the clamp leaks or is at risk of leaking fluid from the pipes, and in dependence upon the determination performing steps of the method.

Advantageously, the method may be performed whilst transporting production fluid from a wellbore through the first and second pipes.

Typically, the coupling of the clamp device to the first and second pipe adapter means comprises locating the clamp members of the clamp in interlocking relationship with the first and second adapter means respectively. In the interlocking relationship, the clamp members may be arranged to prevent either or both decoupling of the pipe adapter means from the pipe, and decoupling of the clamp device from the pipe adapter means. In certain such examples, the pipe adapter means may comprise rotatable limbs which may be rotatable to be coupled to or decoupled from the pipe adapter means, and in the interlocking relationship, the clamp members may be arranged to prevent decoupling rotation of the limbs.

The pipe adapter means, e.g. the first pipe adapter means or the second pipe adapter means, may typically define a channel or track for guiding the clamp member into a coupled configuration in which a convex surface of the clamp member may engage a concave end surface of the pipe adapter means.

The method may further comprise driving the clamp members rotatably about one or more pivots.

The actuation means may be configured coupled to a drive part of the first clamp member and a drive part of the second clamp member and may be operable to urge the drive parts apart in order to rotate the one clamp member relative to the other to perform the clamping.

The method may include operating the clamp members using the actuation means. The actuation means may comprise an actuation mechanism coupled to drive parts of the first and second clamp members, and the clamp members may be operated using the actuation mechanism by varying or setting an extent of the actuation mechanism, e.g. an extent between drive parts of the first and second clamp members, between the drive parts.

The actuation mechanism may comprise an arrangement of parts including a tension rod. The method may include using the tension rod to vary or set the extent actuation mechanism between the drive parts. Using the tension rod may comprise pulling the tension rod and securing the tension rod in tension between elements of the actuation means, e.g. secured by fastener means such as nut or any other suitable means. The rod can typically be pulled along its longitudinal axis to extend the arrangement of parts or drive mechansim along an axis perpendicular to the longitudinal axis of the rod.

Optionally, the method further comprises detecting an amount of extension or tension or produced clamping force and adjusting actuation mechanism or a tension rod of the actuation mechanism, based on the amount of detected extension or tension or produced clamping. In addition, the method may further comprise defining a desired tension or extension or produced clamping force and operating any of the actuation mechanism and the tension rod and the actuation means to obtain the desired tension or extension or produced clamping force.

Typically, the method may further comprise deploying an operating tool subsea, and using the operating tool to operate the actuation means to actuate the clamp device.

The method may further comprise using a remotely operated vehicle (ROV) to operate the operating tool. The installation step may further comprise using an ROV to facilitate with subsea positioning of either or both: the first adapter means with respect to the first pipe, and the second adapter means with respect to second pipe. The method may further comprise using an ROV to facilitate with subsea positioning of the clamp device with respect to either or both the first and second pipe adapter means.

According to a sixth aspect of the invention, there is provided a method of facilitating fluid tightness of a subsea pipe ends connection of first and second pipes which are located subsea and arranged longitudinally end to end, the method comprising the steps of: providing a clamp device in accordance with the first aspect of the invention, the clamp device coupled to the first and second pipes; operating the first and second clamp members, varying or setting the spacing between the first and second clamp members along the pipe, thereby urging the pipe ends toward one another to facilitate fluid tightness. The operating the first and second clamp members, may typically include positioning or varying or adjusting or setting a position of at least one of the first and second clamp members. This may determine or vary or set the spacing along the pipes. Such position, varying, adjusting or setting may be along the pipes.

Any of the various aspects of the invention may include one or more further features as described in relation to any other aspect of the invention wherever described herein.

### BRIEF DESCRIPTION OF THE DRAWINGS

There will now be described, by way of example only, embodiments of the invention with reference to the accompanying drawings, in which:

FIG. 1 is a perspective representation of an example pipe connection assembly;

FIG. 2 is a side sectional representation of the pipe connection assembly of FIG. 1;

FIG. 3 is a side view representation of apparatus for maintaining fluid tight connection of pipe ends, in use, according to an embodiment of the present invention;

FIG. 4 is a side sectional representation of the apparatus of FIG. 3, in use;

FIG. 5 is a perspective representation of an adapter device for the apparatus of FIGS. 3 and 4, in an open configuration;

FIG. 6 is a perspective representation of the adapter device of FIG. 5 in a closed configuration;

FIG. 7 is a side view of the adapter device of FIG. 6;

FIG. 8 is a top view of the adapter device of FIG. 6;

FIG. 9 is an end view of the adapter device of FIG. 6;

FIG. 10 is a sectional view of the adapter along the line BB of FIG. 8;

FIG. 11 is a sectional view of the adapter device along the line AA of FIG. 8;

FIG. 12 is a perspective representation of a clamp device for the apparatus of FIGS. 3 and 4;

FIG. 13 is a side view of the clamp device of FIG. 12 in smaller scale;

FIG. 14 is a top view of the clamp device of FIGS. 12 and 13;

FIG. 15 is a side view of the clamp device of FIGS. 12 and 13;

FIG. 16 is a perspective representation of a tool for operating the clamp device of FIGS. 12 and 13;

FIG. 17 is a perspective representation of the tool of FIG. 16 applied to the clamp device, in use; and

FIG. 18 is a flow diagram representation of a method of clamping.

### DETAILED DESCRIPTION OF THE DRAWINGS

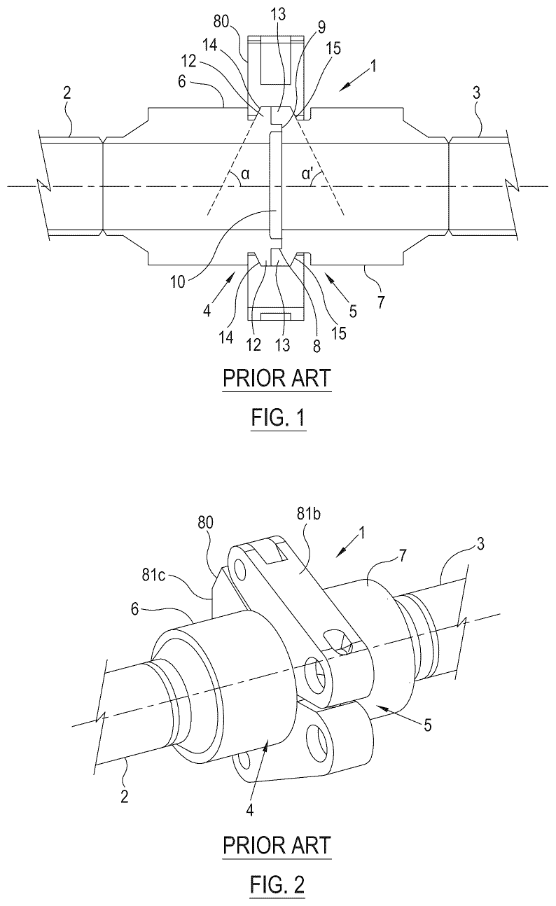

In FIGS. 1 and 2, a pre-existing pipe connection assembly 1 is depicted comprising first and second subsea pipes 2, 3 which are arranged end-to-end. First and second end portions 4, 5 are juxtaposed and connected by a circumferential pipeline clamp 80 which extends around the ends, and which is susceptible to hydrogen induced stress cracking. The first end portion 4 comprises a first end hub 6 which has a formation 8 that protrudes axially from an end surface of the hub. The second end portion comprises a second end hub 7 which has a corresponding formation 9 that is recessed axially from an end surface of the hub. The projecting formation 8 of the first end portion is received in the recessed formation 9 of the second end portion. An annular seal member 10 is fitted between end surfaces of the juxtaposed first and second pipe end portions 4, 5. An outwardly extending flange section 12, 13 extends radially from an outer surface of each of the first and second hubs 6, 7. Rearward surfaces 14, 15 of the flange sections 12, 13 of respective first and second hubs 6, 7 are sloped toward the long axis in the direction away from the ends, at a steep angle with respect to the long axis. The first and second hubs 6, 7 thus together define a structure for the safety clamp 80 to engage in order to urge the ends of the first and second hubs 6, 7 axially toward each other and thus clamp the ends together. The clamp 80 has clamp members in the form of clamp blocks 81a-81c which together extend along the circumference and clamp around the pipe ends. The clamp blocks 81a-81c engage the sloped flange surfaces 14, 15. The clamp 80 is typically tightened with a tightening screw. As the clamp blocks 81a-81c are tightened, the radial space is confined, an outer portion of the juxtaposed flanges 12, 13 are trapped in a radially extending groove of the blocks, and the ends of the first and second pipes 2, 3 are urged together axially. By way of the sloped surfaces 14, 15, axial clamping force components applied to the pipe ends is increased as the clamp blocks 81a-81c increasingly tighten radially around the flanges 12, 13, the sides of the groove in the clamp blocks hindering axial movement between the ends. The seal member 10 prevents fluid in the pipes, e.g. gas or liquid, from escaping and/or fluid from the environment entering.

After long term use subsea, the pipe connection assembly 1 of FIGS. 1 and 2 may deteriorate through hydrogen induced stress cracking. The pipe contents for example comprises oil, gas, and/or other harmful and/or potentially polluting substances. The clamp 80 may fail to maintain fluid tightness of the pipe ends connection. In various examples herein, apparatus and/or methods are applied, as will be described further in the following, to facilitate, provide, or obtain fluid tightness of pipe ends connections such as that described above. In various examples, the failure or condition of the clamp 80 is detected, and the apparatus and/or methods are applied following detection of the failure or condition.

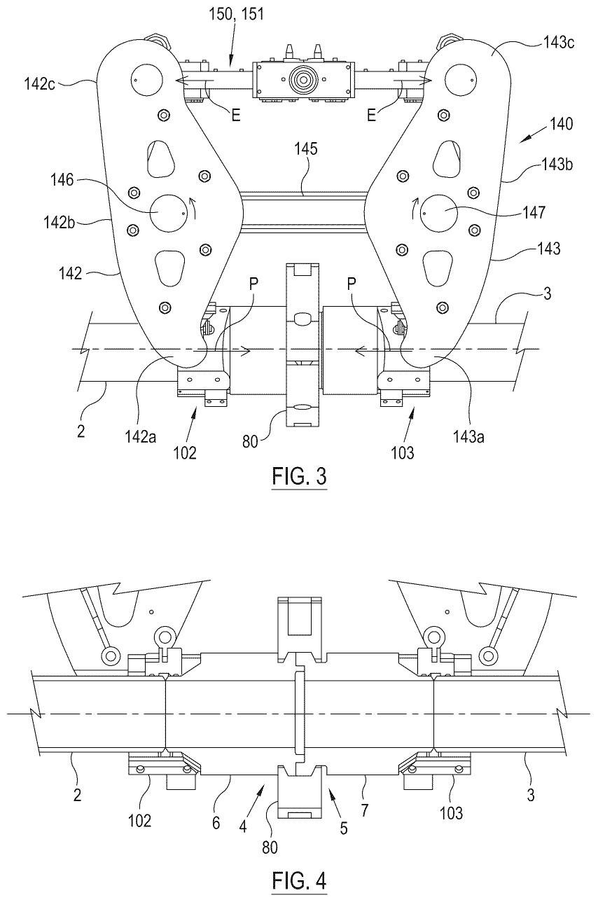

With reference to FIGS. 3 and 4, there is generally depicted at reference numeral 101, apparatus for facilitating fluid tightness of a subsea pipe ends connection of first and second pipes arranged longitudinally end to end. The apparatus 101 includes first and second pipe adapter means 102, 103 which are located respectively on first and second pipes 2, 3 adjacent to first and second end hubs 6, 7. The first pipe adapter means 102 is coupled to the first pipe on one side of the connection, rearward of the first pipe end, and the second pipe adapter device 103 is coupled to the second pipe on the opposite side of the connection, rearward of the second pipe end. The first pipe adapter means 102 has a fixed position longitudinally relative to the first pipe 2 and second pipe adapter means 103 has a fixed position longitudinally fixed relative to the second pipe 3.

The apparatus 101 includes a longitudinal clamp device 140 configured to be coupled to the first and second pipe adapter means 102, 103. The clamp device 140 has clamp members 142, 143 which define a spacing therebetween, e.g. a clamp space, which can be varied longitudinally, and actuation means 150 for operating the first and second clamp members 142, 143 to vary the spacing longitudinally. Through actuation of the clamp members, the clamp device is coupled to the first and second pipe adapter means 102, 103, and the clamp members 142, 143 are driven to clamp the first and second pipe adapter means 102, 103, locating within the spacing, exerting a clamping force upon the parts of the first and second adapter means received in the spacing, thereby urging the one pipe end toward the other to facilitate fluid tight connection between the pipe ends.

More specifically, clamp portions of the first and second clamp members 142, 143 in engagement respectively with the first and second pipe adapter means 102, 103 are driven by the actuation means 150 in opposite directions toward one another along the first and second pipes 2, 3. The clamp members 142, 143 push in opposite directions longitudinally against the first and second pipe adapter means 102, 103 and thus urge the first and second pipe adapter means 102, 103, along with the first and second pipes 2, 3, toward one another longitudinally.

The actuation means 150 comprises an actuation mechanism 151 that is variable in extent, e.g. expandable and collapsible, for operating the clamp members 142, 143. The actuation mechanism 151 comprises an arrangement of coupled parts 152 which is variable in extent between drive parts of the first and second clamp members 142, 143. This is described in further detail below.

The first and second clamp members 142, 143 in this example are arranged to rotate about pivots 146, 147 for moving the clamp end portions of the first clamp member toward the clamp end portions of the second clamp member and thus reducing the space longitudinally for longitudinal clamping, as indicated by arrows P. The actuation mechanism 151 operates to drive rotation of the clamp members about pivots 146, 147 by driving the drive parts of the clamp members apart as indicated by arrows E. In this example, the clamp members 142, 143 are supported on a supporting body 145 and arranged to rotate about pivots 146, 147. Other configurations can be employed for providing and suitably operating the clamp members to vary the spacing between the clamp members longitudinally and engage the pipe adapter means to clamp the pipe ends together. In other variants, the clamp device uses one pivot and either or both the first and the second clamp members are coupled to suitable actuation means and driven to rotate about the one pivot.

The force exerted by the actuation mechanism 151 determines the torque, and thus the clamping force in the longitudinal direction imparted to the first and second pipe adapter means 102, 103. The clamp device 140 in this example bridges the pipe connection 1 with the circumferential clamp 80 thereupon.

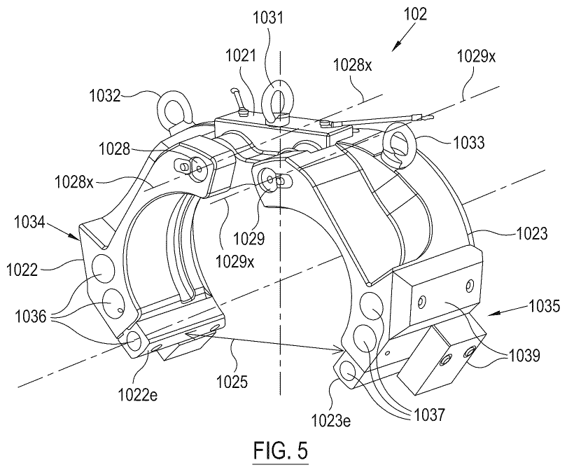

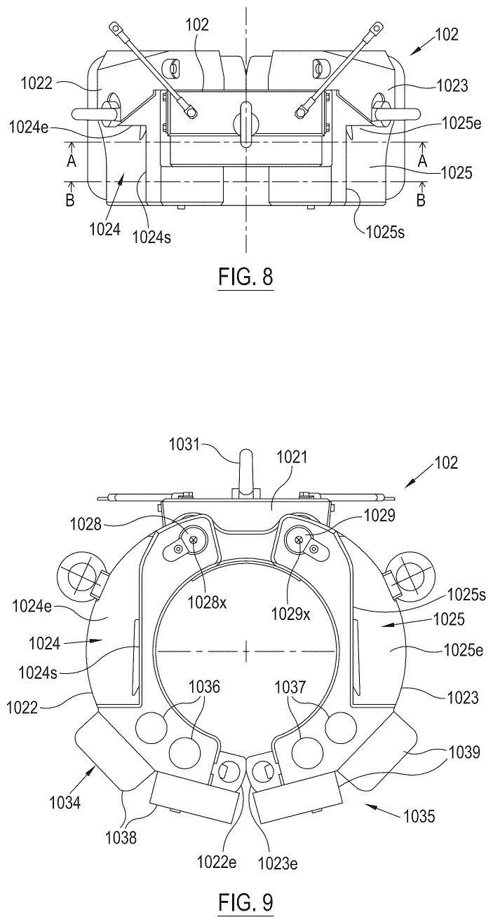

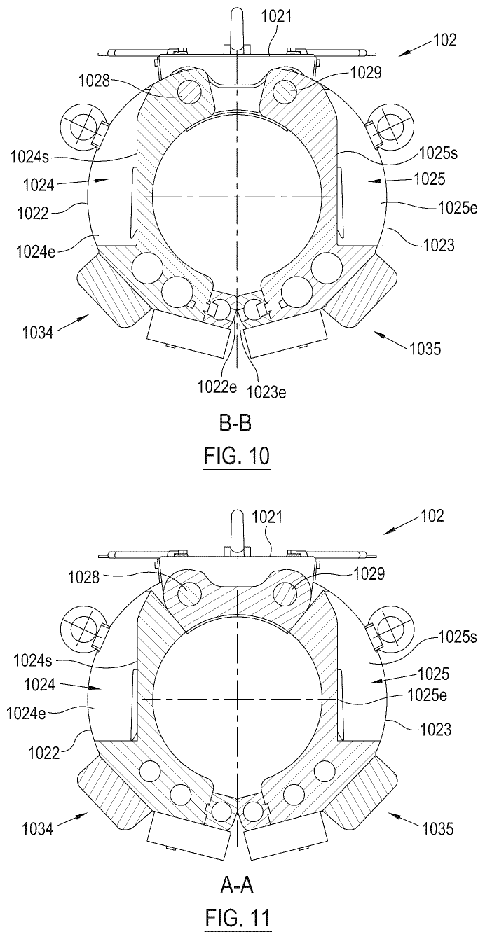

In further detail now with reference to FIGS. 5 to 11, the first pipe adapter means 102 is generally depicted. The second pipe adapter means 103 is configured in the same manner. For brevity, typically only the first pipe adapter means 102 is referred in the description of FIGS. 5 to 11, and this is referred to merely as the pipe adapter means 102.

The pipe adapter means 102 is configured to be lowered through sea and located on the pipe 2. The pipe adapter means 102 comprises a body 1021 to which first and second limbs 1022, 1023 are coupled. The first and second limbs each comprise a curved inner structure to fit and match the outer surface curvature of the pipe 2 in the direction along the circumference of the pipe 2. The first and second limbs 1022, 1023 are arranged to rotate relative to the body 1021 and each other. The first and second limbs 1022, 1023 are arranged to rotate on pivots 1028, 1029 about pivot axes 1028x, 1029x. Thus, the first and second limbs 1022, 1023 are rotatably movable to move limb ends 1022e, 1023e apart for locating the adapter on the pipe 2. Rotation of the first and second limbs 1022, 1023 outwardly opens a gap 1025 between limb ends which the pipe passes through in order to locate the pipe adapter device on the pipe 2 with the first and second limbs 1022, 1023 located around an outer surface of the pipe 2.

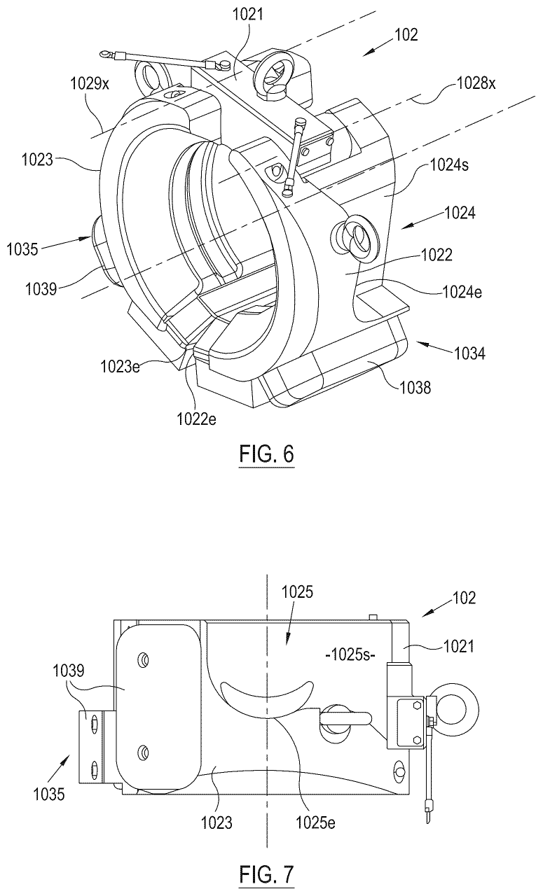

The pipe adapter means 102 is provided with lifting formations 1031, 1032, 1033. Each of the lifting formations 1031, 1032, 1033 in this example comprises an eyelet configured to receive a lifting line therethrough for coupling the line to the lifting formation. The pipe adapter means 102 can thus be suspended in the sea via the one or more lifting lines and lifting formations. The first lifting formation 1031 is provided centrally on the body 1021, the second lifting formation 1032 is provided on the first limb 1022, and the third lifting formation 1033 is provided on the second limb 1023. The opening and closing of the pipe adapter means 102 can be controlled via the lines connected to the second and third lifting formations 1032, 1033. By operating the lines so that lines connecting to the second and third lifting formations 1032, 1033 take the weight of the pipe adapter means 102 in the water, the first and second limbs 1022, 1023 are rotated outwardly and held in open configuration. By releasing the weight on the lines connecting to the lifting formations 1032, 1033, once the pipe adapter means is landed on the pipe with the body 1021 resting or supported on an upper portion of the pipe, the first and second limbs 1022, 1023 can automatically rotate downward and inward by gravity. Thus, the limbs 1022, 1023 are configured to close onto the pipe 2 in use by gravity. The closed configuration is depicted in FIG. 6.

A lower portion of each limb is provided with weight distribution means 1034, 1035. The weight distribution means 1034, 1035 includes holes 1036, 1037 and clump weights 1038, 1039. Thus, the mass of each limb 1022, 1023 is distributed to be greater toward the lower end of each limb. When the adapter device 102 is in the closed position on the pipe 2, the limb ends are located on an underside of the pipe and provide a stable structure on the pipe, with the center of gravity lower than the pipe center.

The limbs 1022, 1023 each has a side recess 1024, 1025. The side recesses 1024, 1025 are configured to receive first clamp portions of the first clamp member 142. The recesses are configured to complement the first clamp portions. In this example for example, the recesses each has an end surface portion which is concave in shape for complementary fit and engagement with convex surface portion of the first clamp portion in the recess. The first clamp portions are in the form of legs which straddle the first pipe adapter means with one leg end located in each side recess 1024, 1025. The recess 1024, 1025 has side surface portions 1024s, 1025s and the legs have inner surface portions which face the side surface portions 1024s, 1025s when located in the recesses. The recesses 1024, 1025 are configured to permit the first clamp portions to be positioned in the recesses 1024, 1025 when the pipe adapter means 102 is installed on the pipe 2. The clamp portions are then initially located in a first position along the recesses 1024, 1025. The recesses 1024, 1025 are further configured permit the clamp portions each to move longitudinally along the recess upon actuation and/or as the clamp space is reduced toward a second, end position in which the clamp portion in each recess locates in abutment with the end surface portion 1024e, 1025e for coupling and clamping to the pipe adapter means 102. In this end position, the first clamp portion is positioned so that the clamp member 142 is coupled to the pipe adapter means 102 and can transmit force longitudinally to the pipe adapter means 102. The recesses 1024, 1025 are configured to permit movement of the clamp portions along the slot toward the end position as the clamp spacing closes.

Surface portions 1024e, 1025e, 1024s, 1025s can facilitate guiding the first clamp portions longitudinally toward the end position upon actuation of the clamp members 142, 143. The surface portions of the recess are configured to interlock with parts of the clamp portions in the end position to hinder the clamp device from decoupling from the pipe adapter means. By coupling the clamp device 140 to the first and second pipe adapter means 102, 103, through locating the first clamp portions of first clamp member 142 in the recesses 1024, 1025 of the first pipe adapter means 102, and second clamp portions of the second clamp member 143 in the recesses 1024, 1025 of the second pipe adapter means 103, the limbs of the first and second pipe adapter means are prevented from decoupling from the pipes 2, 3.

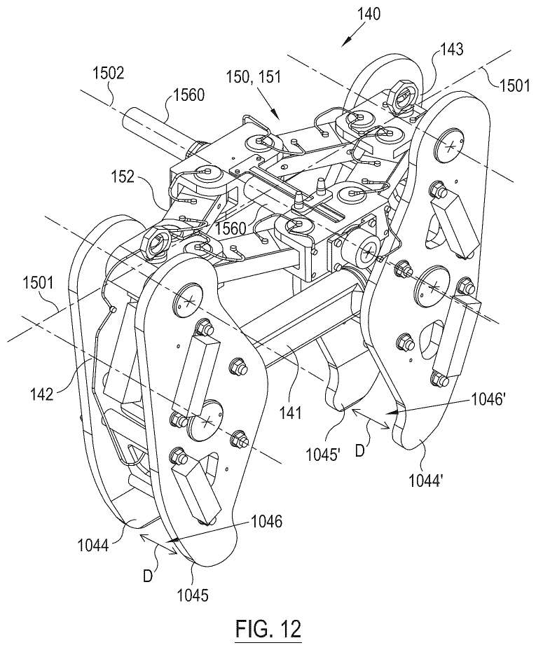

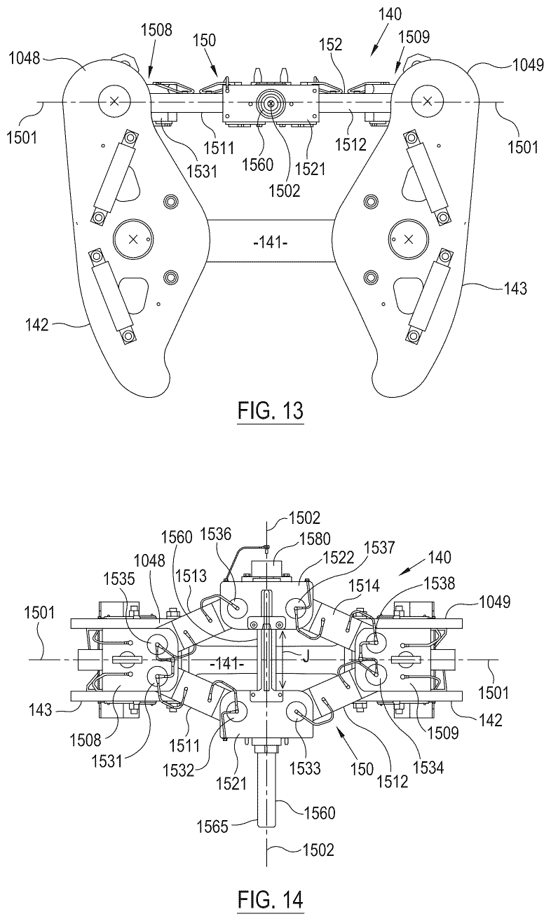

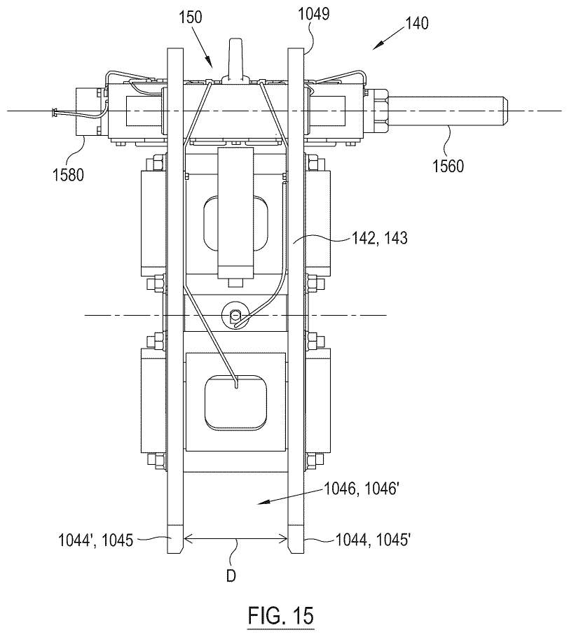

With reference now to FIGS. 12 to 15, the longitudinal clamp device 140 is described in further detail. The clamp device 140 has a first clamp member 142 rotatably coupled to connecting body 141, and a second clamp member 143 also rotatably coupled to the connecting body 141. The clamp member 142 has first clamp portions 1044, 1045 to engage with the first pipe adapter means 102, and the clamp member 143 has second clamp portions 1044′, 1045′ to engage with the second adapter means 103. The clamp device 140 is arranged to slot onto the first and second adapter devices 102, 103. To this end, the first clamp portions 1044, 1045 are in the form of legs spaced apart by distance D and the first pipe adapter means 102 locates through the region 1046 between the first clamp portions 1044, 1045, and similarly the second clamp portions 1044′, 1045′ are in the form of legs spaced apart by distance D and the second pipe adapter means 103 locates [is received] in the region 1046′ between the second clamp portions 1044′, 1045′, when the clamp device 140 is positioned onto the adapter device 102 and 103 for operation and coupling thereto. Once slotted onto the first and second pipe adapter means 102, 103, the adapter means 102, 103 are received in the spacing between clamp members, and the clamp members 142, 143 can be operated to urge the first and second clamp portions toward one another longitudinally so that the first and second clamp portions impart a component of force longitudinally against the end surfaces of the recesses 1024, 1025 of the respective first and second pipe adapter means 102, 103 in opposite directions, which thus urges the pipe end portions 4, 5 toward one another and clamps the pipe ends 4, 5 together.

The longitudinal clamp device 140 includes the actuation mechanism 151 which is coupled and variable in extent between drive parts 1048, 1049 of the first and second clamp members 142, 143. The actuation mechanism 151 includes an extendable arrangement 152 of coupled parts, including a first coupler 1508 and a second coupler 1509 through which the actuation mechanism 151 is coupled to the respective drive parts 1048, 1049 of the first and second clamp members 142, 143. More specifically, the first and second couplers 1508, 1509 are spaced apart along a linear drive axis 1501. The arrangement 152 can thus extend or retract between the points of coupling of the couplers 1508, 1509 to the drive parts 1048, 1049, along the drive axis 1501. Upon extension of the arrangement 152, the drive parts 1048, 1049 of the first and second clamp members 142, 143 are driven apart from one another.

The arrangement 152 links the first coupler 1508 and the second coupler 1509 through a first linkage which includes in this example first and second links 1511, 1512 and a first intermediate element 1521. The first link 1511 extends between the first intermediate element 1521 and the first coupler 1508. The second link 1512 extends between the first intermediate element 1521 and the second coupler 1509. The first link 1511 is coupled to the first coupler 1508 through a first rotational connection 1531 and coupled to the first intermediate element through a second rotational connection 1532. The second link 1512 is coupled to the first intermediate element 1521 through a third rotational connection 1533 and coupled to the second coupler 1509 through a fourth rotational connection 1534.

The arrangement 152 further links between the first coupler 1508 and the second coupler 1509 through a second linkage which includes in this example third and fourth links 1513, 1514 and a second intermediate element 1522. The third link 1513 extends between the second intermediate element 1522 and the first coupler 1508. The fourth link 1514 extends between the second intermediate element 1522 and the second coupler 1509. The third link 1513 is coupled to the first coupler 1508 through a fifth rotational connection 1535 and coupled to the second intermediate element 1522 through a sixth rotational connection 1536. The fourth link 1514 is coupled to the second intermediate element 1509 through a seventh rotational connection 1537 and coupled to the second coupler 1509 through an eighth rotational connection 1538.

The first and third links 1511, 1513 extend from the first coupler 1508 in a V-shape widening toward the central region where they connect to the respective first and second intermediate elements 1521, 1522. The second and fourth links 1512, 1514 extend from the second coupler 1509 in a V-shape in the opposite direction widening toward the central region where they connect to the respective first and second intermediate elements 1521, 1522.

The arrangement 152 is arranged so that when the first and second intermediate elements 1521, 1522 of the first and second linkages are actuated to move toward one another along a second axis 1502, the first and second couplers 1508, 1509 are driven apart from one another along the first, drive axis 1501 which first, drive axis 1501 is perpendicular to the second axis 1502. Thus, the arrangement 152 can in this way be varied in extent between the drive parts through actuation of the intermediate elements 1521, 1522. More specifically, the first and second intermediate elements 1521, 1522 are arranged to be actuated in order to vary the distance J therebetween and in turn vary the extent of the arrangement 152 along the first, drive axis 1501 and thus the distance between the first and second couplers 1508, 1509.

To this end, the arrangement 152 is operated to vary in extent, e.g. extend and retract, using a tension rod 1560. The tension rod 1560 is used to position the intermediate elements 1521, 1522 suitably relative to one another along the second axis 1502. The tension rod 1560 extends longitudinally along the second axis 1502 between the first and second intermediate elements 1521, 1522. The tension rod 1540 in this example has a portion connected to the second intermediate element 1522 and a portion that extends through a section of the first intermediate element 1521. Thus, the tension rod 1560 can be pulled longitudinally along the second axis 1502 to bring the intermediate elements 1521, 1522 toward one another. The rod has a longitudinal rod axis that is coincident with the second axis 1502. The first intermediate element 1521 moves along the rod toward the second intermediate element 1522, along the second axis 1502. The first intermediate element 1521 can also be moved along the rod away from the second intermediate element if required. The tension rod 1560 can thus be operated to urge the intermediate elements 1521, 1522 apart or toward one another along the rod. The intermediate elements 1521, 1522 are coupled to the rod, and the first linkage transmits a component of force to the first intermediate element 1521 in one direction along the rod and axis 1502, and the second linkage transmits a component of force to the second intermediate element 1522 in an opposite direction along the rod axis 1502, such that the rod 1560 between the first and second intermediate elements 1521, 1522 is arranged in tension. Means are provided also to hold the intermediate elements in position along the rod. The rod is tensioned between the intermediate elements under clamping. The movement in this way of the intermediate elements 1521, 1522 can thereby vary the configuration and extent of the actuation mechanism 151 between the drive parts 1048, 1049 of the clamp device. By operating the rod 1560 therefore, the clamp device 140 can be operated to engage the clamp members in or disengage the clamp members from clamping.

More specifically, reducing the distance J between the intermediate elements 1521, 1522 in the direction along axis 1502, which is transverse to the drive axis 1501, steepens the angles of the arms with respect to the axis 1502 (narrows the V-shapes) and increases the distance between the first and second couplers 1508, 1509. In turn, the drive parts 1048, 1049 of the clamp members 142, 143 are pushed away from one another, the clamp members 142, 143 rotate about the pivot axes with respect to the connecting body 141, whilst the first clamp portions of the first clamp member 142 are moved longitudinally toward the second clamp portions of the second clamp member 143, for coupling and clampingly engaging the clamp device to the first and second clamp pipe adapter means 102, 103 therebetween. Conversely, increasing the distance J between the intermediate elements 1521, 1522 in the direction along the second axis 1502 lessens the angles of the arms with respect to the first axis 1501 (widens the V-shapes) and reduces the distance between the first and second couplers. In turn, the drive parts 1048, 1049 of the clamp members 142, 143 move further apart, the clamp members 142, 143 rotate about the axes of rotation 146, 147 with respect to the supporting body 141, and the first clamp portions of the first clamp member 142 driven longitudinally away from the second clamp portions of the second clamp member 143, for releasing and decoupling the longitudinal clamp device 140 from the pipe adapter means 102, 103.

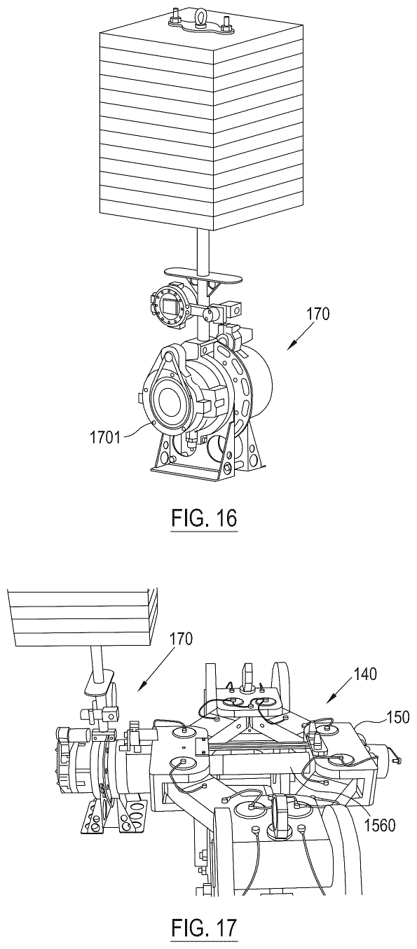

The tension rod 1560 is configured to be operated by an operating tool 170 such as depicted in FIG. 16. The tension rod 1560 has an operating portion in the form of a rod end portion 1565 extending from the first intermediate element 1521. The operating tool 170 is configured to engage with the rod end portion 1565 for pulling the rod relative to the first intermediate element 1521. The operating tool 170 has a receptacle 1701 for receiving the rod end portion 1565 and coupling means for coupling to the rod end portion 1565 and pulling the rod 1560 along its longitudinal axis relative to the first intermediate element 1521. Further the rod 1560 is provided with a nut and the operating tool 170 turns the nut about the rod 1560 and tightens it against a body of the first intermediate element 1521 to maintain or lock the position of the first and second intermediate elements 1521, 1522 along the rod, and during clamping to maintain the tension of the rod 1560 between the intermediate elements 1521, 1522 and maintain the clamping force exerted by the clamp members 142, 143. The operating tool 170 has drive means 1702 configured to operate the coupling means to engage with the tension rod 1560 and exert a pulling force upon the rod 1560 relative to the first intermediate element 1521. The drive means 1702 also operates nut engager to rotate and tighten the nut on the rod 1560 against the body of the first intermediate element 1521. The drive means 1702 can comprise one or more motors, actuators, drive shafts, or gripping members. The drive means 1702 of the operating tool 170 can for instance be controlled from remotely operated vehicle (ROV).

In FIG. 17, the operating tool 170 is coupled to the tension rod 1560 for operating the clamp device. The operating tool is typically coupled when required to the tension rod 1560 of the actuation mechanism 151, as shown in FIG. 17, and can apply the pulling force to the tension rod 1560 and turn the nut on the tension rod 1560 to operate the actuation mechanism 151 and adjust the position or configuration of the intermediate elements 1521, 1522 relative to one another along the rod and thus adjust the clamping force of the clamp device. The tension of the tension rod 1560 can be detected by tension detector 1580. The tension rod 1560 can be set to obtain the desired tension and clamping force in the device, and thus obtain a suitable clamping force for the clamping the pipe ends. The tension can be measured and/or monitored and the tension of the rod 1560 adjusted if necessary, by pulling the rod 1560 and/or turning the nut on the rod 1560, to adjust the position or configuration of the intermediate elements 1521, 1522 relative to one another along the rod 1560 and thus obtain desired tension force and/or maintain good clamping performance. Fine adjustment of the clamping force can be advantageously achieved through the pulling of the rod and/or rotation of the nut of the actuation mechanism. Sufficient force and clamping performance may be obtained without overstressing or damaging parts of the pipe connection or clamping apparatus.

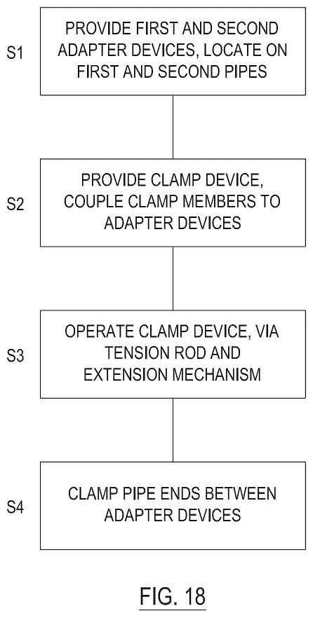

With reference to FIG. 18, the apparatus described above including the first and second pipe adapter means 102, 103, the clamp device 140, and the operating tool 170 can be installed and applied in a method with various steps S1 to S4.

At S1, first and second pipe adapter means 102, 103 are provided and located on the first and second pipes 2, 3. Typically, the first pipe adapter means 102 is suspended and located in the water on lifting lines from a surface vessel or platform. At least one lifting line section passes through the eyelet 1032 of the first limb 1022, and at least one lifting line section passes through the eyelet 1033 of the second limb 1023. The first pipe adapter means 102 is lowered, with the lifting lines taking the weight of the first pipe adapter means 102, through the water toward the seabed. Using the lifting lines, the first pipe adapter means 102 is configured so that the limbs 1022, 1023 are held apart to allow the first pipe adapter 102 to be located on the pipe 2 and the limbs 1022, 1023 fitted around the sides of the pipe 2. To this end, the weight of the first pipe adapter device 102 is transferred to the lifting lines connecting at the flanks to the eyelets 1032, 1033 of the first and second limbs 1022, 1023, achievable for example by releasing the tension on the lifting line of the intermediate body 1021. The first pipe adapter means 102 is then landed on the subsea pipe 2, whereby an inner surface portion of the intermediate body 1021 contacts an upper surface portion of the first pipe 2. In examples where the pipe 2 comprises a pipe end hub 6 which has an outer diameter that is greater than the pipe main body, the first pipe adapter means 102 is located at a position along the first pipe adjacent to and in abutment axially against the pipe end hub 6. A remotely operated vehicle (ROV) is used to assist, if necessary, with the axial positioning of the first adapter device 102 along the pipe 2, as the first adapter device 102 is lowered and landed onto the pipe. Once positioned axially, the first and second limbs 1022, 1023 of the first adapter device 102 are closed around the pipe 2. To do so, the tension on the lifting lines connecting to the first and second limbs 1022, 1023 is relaxed whilst the intermediate body 1021 rests on the pipe 2. The first and second limbs 1022, 1023 close naturally under the weight of gravity so that they extend around the sides of the first pipe 2. The lifting lines are disconnected from the first pipe adapter means 102. To assist with axial positioning a lifting line may be passed through the eyelet 1031 of intermediate body 1021, and using this line the adapter means can be manipulated or adjusted in position circumferentially and/or axially with respect to the pipe, whilst the lines to the first and second limbs are removed or relaxed. The second pipe adapter means 103 is typically deployed and located on the second pipe 3, in the same way as described above for the first pipe adapter means 102.

At S2, the clamp device 140 is provided and coupled to the first and second pipe adapter means 102, 103. The clamp device 140 is lowered into the sea on lifting lines and fitted onto the first and second pipe adapter means 102, 103. The first adapter means 102 is received between the first clamp portions 1044, 1045 of the first clamp member 142 and the second adapter device is received between the second clamp portions 1044′, 1045′ of the second clamp member 143. The clamp members 142, 143 thus extend into the complementary recesses of the first and second adapter means. The engager portions 1044, 1045, 1044′, 1045′ of the clamp members 142, 143 interlock with and/or engage surfaces of the recesses for subjecting the pipe ends between the clamp members 142, 143 to an axial component of clamping force.

At S3 & S4, the clamp device is operated via the tension rod and actuation mechanism 151 and acts to clamp the pipe ends together between the adapter devices 102, 103. The operating tool 170 is provided subsea. The operating tool 170 is activated by an ROV. The operating tool 170 is coupled to the tension rod 1560 of the actuation mechanism 151. The operating tool 170 upon activation pulls the tension rod 1560 of the actuation mechanism 151 to extend the distance between the drive parts 1048, 1049 of the first and second clamp members 142, 143 along the first, drive axis 1501. The operating tool 170 in addition tightens the nut against the first intermediate member 1521 to maintain and/or further adjust the tension of the rod 1560 between the first and second intermediate members 1521, 1522. In turn the clamp members 142, 143 at the clamp portions are urged toward one another into engagement with the end surfaces 1023e, 1024e of the recesses of the first and second pipe adapter device and clamping the pipe ends toward one another in the region between the first and second pipe adapter means 102, 103.

In further steps, the operating tool 170 may be further operated to adjust the tension and/or clamping force of the clamp device, e.g. if needed. In various examples, a component of force or tension in the extension mechanism is measured, and the adjustment of the tension and/or clamping force is performed if determined to be desirable based upon the measured component force or tension.

In other steps, the connection is pre-provided with a first clamp and the fluid tightness of that joint is detected. The apparatus described above is deployed and used if needed based on the detection of the fluid tightness.

The first linkage and the second linkage cooperate to vary an extent of the actuation mechanism 151 along the first drive axis 1501. The tension rod 1560 extends between the first and second linkages along the second axis 1502 which is perpendicular to the first axis. The first linkage couples to the rod through a first element, e.g. the first intermediate element, at a first position along the rod, and the second linkage couples to the rod through a second element, e.g. the second intermediate element at a second position along the rod. The first and second elements can be moved toward or away from one another along the rod, e.g. by pulling or manipulating the rod relative to either or both the first and second elements. The tension rod is configured to support the linkages relative to the rod, and further configured to be tensioned between the first and second linkages, more specifically in tension between the first and second positions at which the first and second linkages are coupled thereto, with the clamp members engaging the pipe adapter means to exert the longitudinal clamping effect thereupon.

By way of the examples of the apparatus including the longitudinal clamp device 140 and pipe adapter means 102, 103 described above, the application of a large clamping force onto the outside of the adapter devices or pipe end hubs 6, 7 can advantageously be provided without interfering with the existing connection to remove the previous clamp or stopping production through the pipeline. Being able to control the clamping force using the tension tool 170 can be advantageous for applying the exact force needed for a specific pipe connection. The fluid integrity of the connection between pipe ends can be preserved and/or remedied by means of the apparatus 101, and the apparatus 101 can be applied with limited of no downtime in production. The present solution provides conveniently a subsea clamping system for already installed pipe ends. The longitudinal clamp device 140 can secure the connection of subsea riser/spool hubs if original clamp solution is subject to failure.

Various examples can be defined as set out in the following numbered Sub-Paragraphs:
1. A clamp device for facilitating fluid tightness of a subsea pipe ends connection between first and second pipes arranged end to end, the clamp device comprising:
first and second clamp members for urging the pipe ends together in use by varying or setting a spacing between the first and second clamp members along the pipes; and
actuation means for operating the first and second clamp members to vary or set the spacing.
2. A clamp device as claimed in Sub-Paragraph 1, having a bridge structure configured to extend over the pipe ends connection from the first pipe on one side to the second pipe on the other side of the pipe ends connection.
3. A clamp device as claimed in Sub-Paragraph 1 or 2, wherein the first and second clamp members are coupled and arranged for rotational movement therebetween, first and second clamp members being movable toward or away from one another through rotational movement therebetween, through which movement the spacing between the first and second clamp members along the pipes is variable or settable.
4. A clamp device as claimed in any preceding Sub-Paragraph, wherein the actuation means comprises an actuation mechanism which comprises an arrangement of coupled parts and which is extendable and retractable in extent between drive parts of the first and second clamp members.
5. A clamp device as claimed in Sub-Paragraph 4, wherein the actuation mechanism comprises a tension rod.
6. A clamp device as claimed in Sub-Paragraph 5, wherein the tension rod is operable for varying or setting the extent of the actuation mechanism.
7. A clamp device as claimed in Sub-Paragraph 5 or 6, wherein the tension rod is coupled to first and second elements of the arrangement and configured to be tensioned therebetween.
8. A clamp device as claimed in Sub-Paragraph 7, wherein a first portion of the tension rod is arranged to engage with the first element at a first position along the rod and a second portion of the tension rod is arranged to engage with the second element at a second position along the rod, and the tension rod is configured to be pulled longitudinally for setting or reducing the distance between the first and second elements along the rod and extending or setting the extent of the actuation mechanism between the first and second drive parts, the tension rod being configured to be pulled by an operating tool so that when the clamp device in use operates to urge the pipe ends together, the rod is arranged in tension between the first and second elements and so that upon pulling the rod, the force exerted upon the first and second drive parts driving the first and second drive parts away from one another may be increased and the tension of the rod between the first and second elements may be increased.
9. A clamp device as claimed in Sub-Paragraph 7 or 8, wherein the tension rod is provided with a nut and is lockable in tension between the first and second elements via the nut.
10. A clamp device as claimed in Sub-Paragraph 9, wherein the nut on the tension rod is configured to be tightened to vary or set the amount of tension.
11. A clamp device as claimed in any of Sub-Paragraphs 5 to 10, wherein:
the clamp device further comprises at least one sensor or detection means configured for any of: detecting an amount of extension of the actuation mechanism, detecting an amount of tension of a tension rod of the actuation mechanism, detecting an amount of clamping force produced by the clamp device when in use; and
the actuation mechanism is operable to vary or adjust or set the first and second clamp members, in response to or in dependency upon the detected amount.
12. Apparatus for facilitating fluid tightness of a subsea pipe ends connection of first and second pipes arranged longitudinally end-to-end, the apparatus comprising:
a clamp device according to any preceding claim; and
at least one pipe adapter means for coupling the clamp device to the arrangement of first and second pipes.
13. Apparatus as claimed in Sub-Paragraph 12, wherein the pipe adapter means comprises any one or more of: a collar; a clamp; a ring structure to extend around the first or second pipe.
14. Apparatus as claimed in Sub-Paragraph 12 or 13, wherein the pipe adapter means comprises a structure configured to complement and interlock, engage or couple with a part of the first or second clamp member.
15. Apparatus as claimed in Sub-Paragraph 14, wherein the structure comprises any of: a recess, a slot, a formation, a groove.
16. Apparatus as claimed in any of Sub-Paragraphs 12 to 15, wherein the pipe adapter means comprises at least one abutment surface arranged to be engaged by at least one portion of the first or second clamp member.
17. Apparatus as claimed in any of Sub-Paragraphs 12 to 16, wherein the pipe adapter means comprises first and second rotatably coupled limbs configured to extend at least partially around the pipe.
18. Apparatus as claimed in any of Sub-Paragraphs 12 to 17, including first pipe adapter means to facilitate coupling the first clamp member to the first pipe and second pipe adapter means to facilitate coupling the second clamp member to the second pipe.
19. Apparatus as claimed in Sub-Paragraph 18, wherein the first and second clamp members are arranged to receive a part of the first pipe adapter means and a part of the second pipe adapter means in the spacing therebetween, and the first and second clamp members may be operable to exert a clamping force to the parts of the first and second pipe adapter means received in the spacing therebetween along the pipes in use.
20. Apparatus as claimed in Sub-Paragraph 19, wherein the first and second clamp members are operable by the actuation means such that at least one clamping portion of the first clamp member be urged along the first pipe against at least one abutment surface of the first pipe adapter means received in the clamp spacing in one direction along the pipes and at least one clamping portion of the second clamp member is urged along the second pipe against at least one abutment of the first of the second pipe adapter means in the clamp spacing in opposite direction along the pipes for urging the pipe ends together in use.
21. Apparatus as claimed Sub-Paragraph 20, wherein the clamping portion of either or both the first and second clamp members comprises a convex surface configured to abut and engage complementary concave surface of the pipe adapter means.
22. Apparatus as claimed in any preceding Sub-Paragraph, further comprising an operating tool for operating the actuating mechanism.
23. Apparatus as claimed in Sub-Paragraph 22, wherein the actuation means comprises an actuation mechanism including a tension rod, and the operating tool is a subsea tool configured to tension the tension rod to maintain or lock the tension rod in tension between first and second elements of the actuation mechanism for setting or increasing the force applied through the clamp members for urging the pipe ends together.
24. Apparatus as claimed in any preceding Sub-Paragraph, wherein the first and second clamp members of the clamp device are rotatable at least one relative to the other about one or more pivots.
25. A system comprising:
a subsea pipe ends connection comprising first and second pipes arranged longitudinally end-to-end; and
a subsea clamp device in accordance with any of Sub-Paragraph 1 to 11.

26. A system as claimed in Sub-Paragraph 25, further comprising at least one pipe adapter means for coupling the clamp device to the first and second pipes.
27. A system as claimed in Sub-Paragraph 25 or 26, wherein the pipe ends connection has a pre-existing clamp applied to the pipe ends, and the clamp device is coupled to the first and second pipes and extends along the pipes bridge-wise over the pipe ends and the pre-existing clamp.
28. A system as claimed in claimed in any of Sub-Paragraph 25 to 27 wherein first pipe adapter means is arranged on the first pipe on one side of the pipe ends connection and second pipe adapter means is arranged on the second pipe on the other side of the pipe ends connection, and the first clamp member is coupled to the pipe through the first pipe adapter means and the second clamp member is coupled to the second pipe through the second pipe adapter means, and the clamp device is coupled to the first and second pipes by the coupling of the first and second clamp members to the first and second pipe adapter means.
29. A system as claimed in Sub-Paragraph 28, wherein the first and second clamp members are urged toward one another by the actuation means operating the first and second clamp members, the first and second clamp members exerting a clamping force upon a part of the first pipe adapter means and a part of the second pipe adapter means received in the spacing between the first and second clamp members of the clamp device to clamp the parts.
30. A system as claimed in any of Sub-Paragraphs 25 to 29, wherein the first and second clamp members each comprise surfaces configured to interlock or engage with surfaces of any of the pipe, pipe means, or pipe adapter means of the first and second pipes respectively.
31. A system as claimed in any of Sub-Paragraphs 25 or 30, which further comprises: at least one pipe adapter means which comprises first and second limbs extending around the pipe which limbs may be rotated from open position to closed position around the pipe for facilitating installation of the pipe adapter means on the pipe; and
the clamp device having a coupled configuration, in which at least one of the first and second clamp members is coupled to the pipe adapter means:
   i) such that the first and second limbs of the pipe adapter means may be locked in location along the pipe and/or prevented or blocked from inadvertent rotation away from the pipe toward open position, or
   ii) such that the clamp device may be locked to the pipe adapter means and/or the clamp member may be blocked by part of the pipe adapter means from decoupling from the pipe adapter means.
32. A system as claimed in any of Sub-Paragraphs 25 to 31, including first and second pipe adapter means, wherein the first clamp member comprises first and second clamping portions configured to interlock and engage with the first pipe adapter means and the second clamp member comprises third and fourth clamping portions configured to interlock and engage with the second pipe adapter means, and the first clamp member is configured to straddle the first pipe adapter means with the first and second clamping portions extending on opposite sides of the first pipe adapter means and/or first pipe, and the second clamp member is configured to straddle the second pipe adapter means with the third and fourth clamping portions extending on opposite sides of the second pipe adapter means and/or second pipe.
33. A pipe adapter device for coupling between a subsea pipe and the clamp device of any of Sub-Paragraphs 1 to 11, the pipe adapter device comprising first and second limbs and at least one recess or slot configured to be engageable or permit coupling thereto by at least one coupling part of a clamp member.
34. A pipe adapter device as claimed in Sub-Paragraph 33, wherein the first limb is arranged to locate around the pipe on one side of the pipe, and the second limb may be arranged to locate around the pipe on an opposite side of the pipe, and the first and second limbs are rotatable from an open position for allowing location of the pipe adapter device on the pipe through receiving the pipe through a gap between the limbs, to an installed position wherein the first and second limbs are located around the pipe on the opposite sides.
35. A pipe adapter device as claimed in Sub-Paragraph 33 or 34, wherein the first and second limb has recesses or slots arranged for receiving therein first and second legs of the clamp member on either side of the pipe.
36. A method of installing a clamp device in accordance with any of Sub-Paragraphs 1 to 11, the clamp device to be installed on first and second pipes which are located subsea and arranged longitudinally end to end and have a subsea pipe ends connection therebetween.
37. A method as claimed in Sub-Paragraphs 36, which further comprises:
installing first pipe adapter means on the first pipe;
installing second pipe adapter means on the second pipe; and
coupling the clamp device to the first and second pipes via the first and second pipe adapter means.
38. A method as claimed in Sub-Paragraph 37, which includes:
operating the first and second clamp members using the actuation means, the first and/or second clamp members being driven toward one another;
reducing the spacing, e.g. clamp space, between the first and second clamp members along the pipes;
coupling the clamp device to the first and second pipes or the first and second pipe adapter means through the movement and reduction or setting of the spacing along the pipes.

39. A method as claimed in Sub-Paragraph 37 or 38, which includes:
arranging the first pipe adapter means in fixed position relative to the first pipe on one side of the pipe ends connection and the second pipe adapter means in fixed position relative to the second pipe on the other side of the pipe ends connection;
operating the first and second clamp members using the actuation means, the first and/or second clamp members being driven toward one another, reducing the spacing therebetween along the pipes;
receiving at least part of the first pipe adapter means and at least part of the second pipe adapter means in the spacing, e.g. clamp space, between the first and second clamp members;
clamping the parts between the first and second clamp members, urging the first and second pipe ends together.
40. A method as claimed in any of Sub-Paragraphs 36 to 39, which includes installing at least one pipe adapter means, which comprises rotatably coupled first and second limbs which are configured to extend along a circumference around the pipe and are rotatable between a first configuration in which the limbs allow the pipe to be received in a region between the first and second limbs and a second configuration in which the limbs are lowered against the pipe on opposite sides thereof, and wherein the step of installation comprises:
landing the adapter means on the pipe in the first configuration; and
letting the first and second limbs rotate under gravity from the first configuration to the second configuration.
41. A method as claimed in Sub-Paragraph 40, which further comprises lowering the adapter means through sea, the adapter means supported on one or more lifting lines, and relaxing at least one lifting line to let the limbs rotate from the first to the second configuration.
42. A method as claimed in any of Sub-Paragraphs 36 to 41, wherein either or both the first and second pipes has a pipe end hub, and the method further comprises arranging a pipe adapter means on the pipe rearward of and in abutment against the pipe end hub, the abutment therebetween hindering longitudinal movement or further longitudinal movement of the pipe adapter means.
43. A method as claimed in any of Sub-Paragraphs 36 to 42, wherein the pipe ends are arranged end to end with a previously installed clamp connecting the ends, and determining whether the previously installed clamp leaks or meets a predetermined level of risk of leaking fluid from the pipes, and in dependence upon the determination performing the steps of the method.
44. A method as claimed in Sub-Paragraph 43 performed without removing the previously installed clamp.
45. A method as claimed in any of Sub-Paragraph 36 to 44, performed whilst transporting production fluid from a wellbore through the first and second pipes.
46. A method as claimed in any of Sub-Paragraphs 36 to 45, which includes providing first and second pipe adapter means, and coupling the clamp device to the first and second pipe adapter means, which includes locating at least one part of the first clamp member in interlocking relationship with the first pipe adapter means and locating at least one part of the second clamp member in interlocking relationship with the second pipe adapter means.
47. A method as claimed in Sub-Paragraph 46, wherein in the interlocking relationship the parts of the first and second clamp members are arranged to prevent either or both decoupling of the first and second pipe adapter means from the first and second pipes, and to prevent decoupling of the clamp device from the pipe adapter means.
48. A method as claimed in Sub-Paragraph 47, wherein at least one of the first and second pipe adapter means comprises rotatable limbs which are rotatable to be coupled to or decoupled from the pipe adapter means, and in the interlocking relationship, the first or second clamp member is arranged to prevent uncoupling of the limbs from the pipe.
49. A method as claimed in any of Sub-Paragraphs 36 to 48, which includes providing at least one pipe adapter means which defines a channel, the channel guiding the clamp member into a coupled configuration in which a convex surface of the clamp member abuts and engages a concave end surface of the pipe adapter means.
50. A method as claimed in any of Sub-Paragraphs 36 to 49, which further comprises deploying an operating tool subsea, and using the operating tool to operate the actuation means to actuate the clamp device.
51. A method as claimed in Sub-Paragraph 50, which further comprises using a remotely operated vehicle (ROV) to operate the operating tool.
52. A method as claimed in any of Sub-Paragraphs 36 to 51, wherein the installation step further comprises using an remotely operated vehicle (ROV) to facilitate with subsea positioning of either or both: the first adapter means with respect to the first pipe, and the second adapter means with respect to second pipe.
53. A method as claimed in any of Sub-Paragraphs 36 to 52, which further comprises using a remotely operated vehicle (ROV) to facilitate with subsea positioning of the clamp device with respect to either or both the first and second pipe adapter means.
54. A method of facilitating fluid tightness of a subsea pipe ends connection of first and second pipes which are located subsea and arranged longitudinally end to end, the method comprising the steps of:
providing a clamp device in accordance with any of Sub-Paragraphs 1 to 11, the clamp device coupled to the first and second pipes;
operating the first and second clamp members, varying or setting the spacing between the first and second clamp members along the pipe, thereby urging the pipe ends toward one another to facilitate fluid tightness.
55. A method as claimed in Sub-Paragraph 54, which further comprises driving the clamp members rotatably about one or more pivots.
56. A method as claimed in Sub-Paragraph 54 or 55, which includes:
providing an actuation mechanism comprising an arrangement of parts coupled to a drive part of the first clamp member and a drive part of the second clamp member; and
operating the actuation mechanism to urge the drive parts apart to operate the first and second clamp members to perform clamping.
57. A method as claimed in Sub-Paragraph 56, which includes:
operating the actuation mechanism between the drive parts of the first and second clamp members to increase or decrease in extent of the actuation mechanism between the drive parts;
moving the arrangement of parts between first and second configurations using a tension rod, wherein in the second configuration the arrangement is compressed along the axis of the tension rod, the drive parts are urged apart for clamping, and the tension rod is tensioned between first and second elements of the arrangement of parts to maintain or obtain the second configuration; and
operating the tension rod to vary the extent of the actuation mechanism, pulling the tension rod along its longitudinal axis to tension the rod.

58. A method as claimed in any of Sub-Paragraphs 54 to 57, which further comprises detecting an amount of tension or produced clamping force and adjusting actuation mechanism or a tension rod of the actuation mechanism, based on the amount of detected tension or produced clamping force.

59. A method as claimed in Sub-Paragraph 58, which further comprises defining a desired tension or produced clamping force and operating any of the actuation mechanism and the tension rod and the actuation means to obtain the desired tension or produced clamping force.

1. A clamp device for facilitating fluid tightness of a subsea pipe ends connection between first and second pipes arranged end to end, the clamp device comprising:
first and second clamp members for urging the pipe ends together in use by varying or setting a spacing between the first and second clamp members along the pipes; and
actuation means for operating the first and second clamp members to vary or set the spacing.

2. The A clamp device as claimed in claim 1, having a bridge structure configured to extend over the pipe ends connection from the first pipe on one side to the second pipe on the other side of the pipe ends connection.

3. The clamp device as claimed in claim 1, wherein the first and second clamp members are coupled and arranged for rotational movement therebetween, first and second clamp members being movable toward or away from one another through rotational movement therebetween, through which movement the spacing between the first and second clamp members along the pipes is variable or settable.

4. The clamp device as claimed in claim 1, wherein the actuation means comprises an actuation mechanism which comprises an arrangement of coupled parts and which is extendable and retractable in extent between drive parts of the first and second clamp members.

5. The clamp device as claimed in claim 4, wherein the actuation mechanism comprises a tension rod.

6. The clamp device as claimed in claim 5, wherein the tension rod is operable for varying or setting the extent of the actuation mechanism.

7. The clamp device as claimed in claim 5, wherein the tension rod is coupled to first and second elements of the arrangement and configured to be tensioned therebetween, wherein a first portion of the tension rod is arranged to engage with the first element at a first position along the rod and a second portion of the tension rod is arranged to engage with the second element at a second position along the rod, and the tension rod is configured to be pulled longitudinally for setting or reducing the distance between the first and second elements along the rod and extending or setting the extent of the actuation mechanism between the first and second drive parts, the tension rod being configured to be pulled by an operating tool so that when the clamp device in use operates to urge the pipe ends together, the rod is arranged in tension between the first and second elements and so that upon pulling the rod, the force exerted upon the first and second drive parts driving the first and second drive parts away from one another may be increased and the tension of the rod between the first and second elements may be increased.

8.-10. (canceled)

11. A The clamp device as claimed in claim 5, wherein:
the clamp device further comprises at least one sensor or detection means configured for any of: detecting an amount of extension of the actuation mechanism, detecting an amount of tension of a tension rod of the actuation mechanism, detecting an amount of clamping force produced by the clamp device when in use; and
the actuation mechanism is operable to vary or adjust or set the first and second clamp members, in response to or in dependency upon the detected amount.

12. An apparatus for facilitating fluid tightness of a subsea pipe ends connection of first and second pipes arranged longitudinally end-to-end, the apparatus comprising:
a clamp device according to claim 1; and
at least one pipe adapter means for coupling the clamp device to the arrangement of first and second pipes.

13. The apparatus as claimed in claim 12, wherein the pipe adapter means comprises:
any one or more of: a collar; a clamp; a ring structure to extend around the first or second pipe; and
a structure configured to complement and interlock, engage or couple with a part of the first or second clamp member.

14.-17. (canceled)

18. The apparatus as claimed in claim 12, including first pipe adapter means to facilitate coupling the first clamp member to the first pipe and second pipe adapter means to facilitate coupling the second clamp member to the second pipe,
wherein the first and second clamp members are arranged to receive a part of the first pipe adapter means and a part of the second pipe adapter means in the spacing therebetween, and the first and second clamp members may be operable to exert a clamping force to the parts of the first and second pipe adapter means received in the spacing therebetween along the pipes in use, and wherein the first and second clamp members of the clamp device are rotatable at least one relative to the other about one or more pivots.

19. (canceled)

20. The apparatus as claimed in claim 18 wherein the first and second clamp members are operable by the actuation means such that at least one clamping portion of the first clamp member be urged along the first pipe against at least one abutment surface of the first pipe adapter means received in the clamp spacing in one direction along the pipes and at least one clamping portion of the second clamp member is urged along the second pipe against at least one abutment of the first of the second pipe adapter means in the clamp spacing in opposite direction along the pipes for urging the pipe ends together in use.

21. (canceled)

22. The clamp device as claimed in claim 11, further comprising an operating tool for operating the actuating mechanism.

23. The clamp device as claimed in claim 22, wherein the actuation means comprises an actuation mechanism including a tension rod, and the operating tool is a subsea tool configured to tension the tension rod to maintain or lock the tension rod in tension between first and second elements of the actuation mechanism for setting or increasing the force applied through the clamp members for urging the pipe ends together.

24. (canceled)

25. A system comprising:
a subsea pipe ends connection comprising first and second pipes arranged longitudinally end-to-end; and
a subsea clamp device in accordance with claim 1.

26. The system as claimed in claim 25, further comprising at least one pipe adapter means for coupling the clamp device to the first and second pipes.

27. The system as claimed in claim 25, wherein the pipe ends connection has a pre-existing clamp applied to the pipe ends, and the clamp device is coupled to the first and second pipes and extends along the pipes bridge-wise over the pipe ends and the pre-existing clamp.

28. The system as claimed in claimed in claim 25 wherein first pipe adapter means is arranged on the first pipe on one side of the pipe ends connection and second pipe adapter means is arranged on the second pipe on the other side of the pipe ends connection, and the first clamp member is coupled to the pipe through the first pipe adapter means and the second clamp member is coupled to the second pipe through the second pipe adapter means, and the clamp device is coupled to the first and second pipes by the coupling of the first and second clamp members to the first and second pipe adapter means.

29. The system as claimed in claim 28, wherein the first and second clamp members are urged toward one another by the actuation means operating the first and second clamp members, the first and second clamp members exerting a clamping force upon a part of the first pipe adapter means and a part of the second pipe adapter means received in the spacing between the first and second clamp members of the clamp device to clamp the parts.

30. The system as claimed in claim 25, wherein the first and second clamp members of the clamp device are rotatable at least one relative to the other about one or more pivots.

31. The system as claimed in claim 25, which further comprises:
at least one pipe adapter means which comprises first and second limbs extending around the pipe which limbs may be rotated from open position to closed position around the pipe for facilitating installation of the pipe adapter means on the pipe; and
the clamp device having a coupled configuration, in which at least one of the first and second clamp members is coupled to the pipe adapter means:
i) such that the first and second limbs of the pipe adapter means may be locked in location along the pipe and/or prevented or blocked from inadvertent rotation away from the pipe toward open position, or
ii) such that the clamp device may be locked to the pipe adapter means and/or the clamp member may be blocked by part of the pipe adapter means from decoupling from the pipe adapter means.

32. The system as claimed in claim 25, including first and second pipe adapter means, wherein the first clamp member comprises first and second clamping portions configured to interlock and engage with the first pipe adapter means and the second clamp member comprises third and fourth clamping portions configured to interlock and engage with the second pipe adapter means, and the first clamp member is configured to straddle the first pipe adapter means with the first and second clamping portions extending on opposite sides of the first pipe adapter means and/or first pipe, and the second clamp member is configured to straddle the second pipe adapter means with the third and fourth clamping portions extending on opposite sides of the second pipe adapter means and/or second pipe.

33. A pipe adapter device for coupling between a subsea pipe and the clamp device of claim 1, the pipe adapter device comprising first and second limbs and at least one recess or slot configured to be engageable or permit coupling thereto by at least one coupling part of a clamp member.

34. The pipe adapter device as claimed in claim 33, wherein the first limb is arranged to locate around the pipe on one side of the pipe, and the second limb may be arranged to locate around the pipe on an opposite side of the pipe, and the first and second limbs are rotatable from an open position for allowing location of the pipe adapter device on the pipe through receiving the pipe through a gap between the limbs, to an installed position wherein the first and second limbs are located around the pipe on the opposite sides,
wherein the first and second limb has recesses or slots arranged for receiving therein first and second legs of the clamp member on either side of the pipe.

35. (canceled)

36. A method of installing a clamp device in accordance with claim 1, the clamp device to be installed on first and second pipes which are located subsea and arranged longitudinally end to end and have a subsea pipe ends connection therebetween.

37. The method as claimed in claim 36, which further comprises:
installing first pipe adapter means on the first pipe;
installing second pipe adapter means on the second pipe; and
coupling the clamp device to the first and second pipes via the first and second pipe adapter means.

38. The method as claimed in claim 37, which includes:
operating the first and second clamp members using the actuation means, the first and/or second clamp members being driven toward one another;
reducing the spacing, e.g. clamp space, between the first and second clamp members along the pipes;
coupling the clamp device to the first and second pipes or the first and second pipe adapter means through the movement and reduction or setting of the spacing along the pipes.

39. The method as claimed in claim 37, which includes:
arranging the first pipe adapter means in fixed position relative to the first pipe on one side of the pipe ends connection and the second pipe adapter means in fixed position relative to the second pipe on the other side of the pipe ends connection;
operating the first and second clamp members using the actuation means, the first and/or second clamp members being driven toward one another, reducing the spacing therebetween along the pipes;
receiving at least part of the first pipe adapter means and at least part of the second pipe adapter means in the spacing, e.g. clamp space, between the first and second clamp members;
clamping the parts between the first and second clamp members, urging the first and second pipe ends together.

40. The method as claimed in claim 37, which includes installing at least one pipe adapter means, which comprises rotatably coupled first and second limbs which are configured to extend along a circumference around the pipe and are rotatable between a first configuration in which the limbs allow the pipe to be received in a region between the first and second limbs and a second configuration in which the limbs are lowered against the pipe on opposite sides thereof, and wherein the step of installation comprises:
landing the adapter means on the pipe in the first configuration; and
letting the first and second limbs rotate under gravity from the first configuration to the second configuration.

41.-42. (canceled)

43. The -method as claimed in claim 37, wherein the pipe ends are arranged end to end with a previously installed clamp connecting the ends, the method performed without removing the previously installed clamp.

44. (canceled)

45. The method as claimed in claim 37, performed whilst transporting production fluid from a wellbore through the first and second pipes.

46. The method as claimed in claim 37, which includes providing first and second pipe adapter means, and coupling the clamp device to the first and second pipe adapter means, which includes locating at least one part of the first clamp member in interlocking relationship with the first pipe adapter means and locating at least one part of the second clamp member in interlocking relationship with the second pipe adapter means.

47. The method as claimed in claim 46, wherein in the interlocking relationship the parts of the first and second clamp members are arranged to prevent either or both decoupling of the first and second pipe adapter means from the first and second pipes, and to prevent decoupling of the clamp device from the pipe adapter means.

48.-49. (canceled)

50. The method as claimed in claim 37, which further comprises deploying an operating tool subsea, and using the operating tool to operate the actuation means to actuate the clamp device.

51.-53. (canceled)

54. A method of facilitating fluid tightness of a subsea pipe ends connection of first and second pipes which are located subsea and arranged longitudinally end to end, the method comprising the steps of:
providing a clamp device in accordance with claim 1, the clamp device coupled to the first and second pipes;
operating the first and second clamp members, varying or setting the spacing between the first and second clamp members along the pipe, thereby urging the pipe ends toward one another to facilitate fluid tightness.

55.-59. (canceled)
